(19) United States
(12) Patent Application Publication
(10) Pub. No.: US 2025/0349170 A1
(43) Pub. Date: Nov. 13, 2025

(54) BANKNOTE CONVEYING APPARATUS, BANKNOTE CONVEYING METHOD, AND NON-TRANSITORY INFORMATION PROCESSING COMPUTER-READABLE RECORDING MEDIUM

(71) Applicants: FUJITSU FRONTECH LIMITED, Tokyo (JP); Fujitsu Frontech Systems Limited, Maebashi-shi (JP)

(72) Inventors: Shinya HIRANO, Inagi (JP); Hiroki OGAWA, Inagi (JP); Hiroshi NAKANO, Inagi (JP); Kazuhisa YOSHIMURA, Inagi (JP); Yoshitaku YOSHIMATSU, Inagi (JP)

(73) Assignees: FUJITSU FRONTECH LIMITED, Tokyo (JP); Fujitsu Frontech Systems Limited, Maebashi-shi (JP)

(21) Appl. No.: 19/279,709

(22) Filed: Jul. 24, 2025

Related U.S. Application Data
(63) Continuation of application No. PCT/JP2023/006180, filed on Feb. 21, 2023.

(51) Int. Cl. G07D 11/235; B65H 7/02

(52) U.S. Cl. CPC G07D 11/235; B65H 7/02; B65H 2513/10; B65H 2513/512; B65H 2557/64; B65H 2701/1912; G07D 2211/00

(57) ABSTRACT

A banknote conveying apparatus includes, a conveyance controller that performs a conveying process of sequentially conveying a plurality of banknotes on a conveyance path, a plurality of sensors that detect the conveyed banknotes, and a processor coupled to a memory and configured to, generate a log in which past operation information including a detection result by the sensor is recorded, calculate an abnormality tendency threshold of a conveying speed for conveying a banknote between the sensors based on detection results of the sensors for the plurality of conveyed banknotes included in the log, and calculate a first conveying speed of a specific banknote between the sensors based on the log and determine presence or absence of an abnormality sign in conveyance of the specific banknote between the sensors based on whether the first conveying speed is included in a range indicated by the abnormality tendency threshold.

### CROSS-REFERENCE TO RELATED APPLICATION

This application is a continuation application of International Application PCT/JP2023/006180, filed on Feb. 21, 2023 and designating the U.S., the entire contents of which are incorporated herein by reference.

### FIELD

The present invention relates to a banknote conveying apparatus, a banknote conveying method, and a banknote conveying program.

### BACKGROUND

A banknote handling apparatus such as an automated teller machine (ATM) has a storage that stores deposited banknotes. For example, in the case of cash deposition, when a banknote is put into an insertion/removal port, the automated teller machine conveys the banknote in the apparatus, passes through the distinguishing unit that distinguishes the authenticity or the like of the banknote, and stores the banknote in the storage. Conversely, in the case of cash withdrawal, the automated teller machine conveys the banknote stored in the storage in the apparatus and discharges the banknote to the insertion/removal port.

As such a banknote conveying apparatus that conveys a banknote, in addition to an automated teller machine, various devices such as a cash dispenser (CD) and a teller cash recycler (TCR) are present. Here, in the banknote conveying apparatus, it is considered that a problem occurs in conveying the banknote. Various factors are considered for the occurrence of such a problem, but as an example, it is considered that the resin for the roller expands due to a change in environmental temperature or the like, and the conveyance of the banknote becomes unstable. In addition, in an old banknote or the like, a jam may occur, and the conveyance may be stopped.

In the related art, when a problem occurs in a banknote conveying apparatus, a worker such as a maintenance person acquires a log that is information recording an operation inside the apparatus and grasps a clue for solving the problem from the acquired log to perform analysis, thereby solving the problem. The worker who performs the work needs to sufficiently understand a control condition of the banknote conveying apparatus and a mechanism of the apparatus.

Note that, as a solution to the problem in the conveyance of the banknote conveying apparatus, a technique is proposed in which a first sensor and a second sensor that detect the passage of the banknote are provided, and the abnormality in the conveyance is detected based on the passing time of the banknote between the first sensor and the second sensor. In addition, as a technique of abnormality detection in conveyance of a medium, a technique of specifying an abnormal point based on a position of the medium with respect to a sensor through which the medium passes at the time of occurrence of an abnormality is proposed.
Patent Literature 1: Japanese Laid-open Patent Publication No. H07-234957
Patent Literature 2: Japanese Laid-open Patent Publication No. 2018-58689

However, the log used for analyzing an abnormality factor is the history of the operation of the banknote conveying apparatus in time series, and thus a technician having sufficient knowledge about the banknote conveying apparatus performs an operation of identifying an abnormal point according to the control condition from the time when the abnormality occurs. This work is very man-hour intensive. In addition, this work needs a technician who sufficiently understands the control conditions of the banknote conveying apparatus and the mechanism of the apparatus. For this reason, a hurdle for analyzing an abnormality factor when an abnormality occurs in the banknote conveying apparatus is high, and it is difficult to improve maintainability.

The disclosed technology is conceived in view of the above, and an object thereof is to provide a banknote conveying apparatus, a banknote conveying method, and a banknote conveying program that improve maintainability.

### SUMMARY

According to an aspect of an embodiment, a banknote conveying apparatus includes a conveyance controller that performs a conveying process of sequentially conveying a plurality of banknotes on a conveyance path, a plurality of sensors that are provided on the conveyance path and detect the conveyed banknotes, a memory, and a processor coupled to the memory. the processor configures to generate a log in which past operation information including a detection result by the sensor is recorded, calculate an abnormality tendency threshold of a conveying speed for conveying a banknote between the sensors based on detection results of the sensors for the plurality of conveyed banknotes included in the log, calculate a first conveying speed of a specific banknote between the sensors based on the log and determine presence or absence of an abnormality sign in conveyance of the specific banknote between the sensors based on whether the first conveying speed is included in a range indicated by the abnormality tendency threshold, and provide notification of a determination result.

### BRIEF DESCRIPTION OF DRAWINGS

FIG. 1 is an external view of an automated teller machine.

FIG. 2 is a diagram illustrating an example of a hardware configuration of the automated teller machine.

FIG. 3 is a block diagram of the automated teller machine.

FIG. 4 is a diagram illustrating an example of arrangement of sensors.

FIG. 5 is a diagram of an example of a sensor arrangement table in a feed direction.

FIG. 6 is a diagram of an example of a sensor arrangement table in a back direction.

FIG. 7 is a diagram illustrating an example of a log in the automated teller machine.

FIG. 8 is a diagram illustrating an outline of a banknote conveying process indicated by a log.

FIG. 9 is a diagram illustrating an accumulation example of conveying speed information.

FIG. 10 is a diagram illustrating an example of an abnormality tendency threshold.

FIG. 11 is a diagram illustrating an example of determination result information.

FIG. 12 is a flowchart of an abnormality sign detection process in banknote conveyance by the automated teller machine according to the embodiment.

FIG. 13 is a flowchart of a rendering process by the automated teller machine according to the embodiment.

### DESCRIPTION OF EMBODIMENTS

Hereinafter, embodiments of a banknote conveying apparatus, a banknote conveying method, and a banknote conveying program described in the present application are described in detail with reference to the drawings. Note that the banknote conveying apparatus, the banknote conveying method, and the banknote conveying program described in the present application are not limited by the following embodiments.

### EMBODIMENT

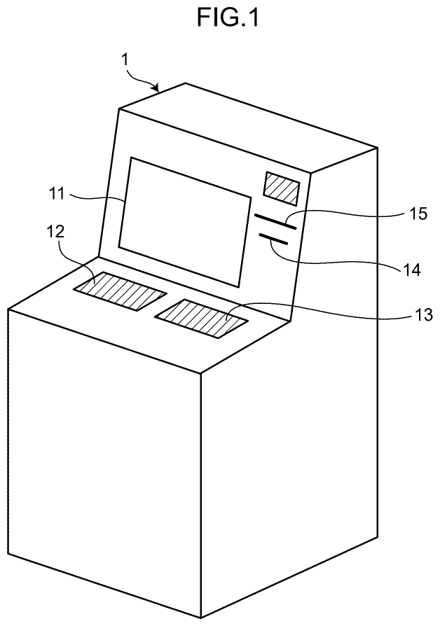

FIG. 1 is an external view of an automated teller machine. An automated teller machine 1 has an appearance illustrated in FIG. 1. The automated teller machine 1 includes a customer operation screen 11, a cash deposit/withdrawal unit 12, a passbook reception unit 13, a card reception port 14, and a receipt issuance port 15. The automated teller machine 1 corresponds to an example of a “banknote conveying apparatus”.

The customer operation screen 11 is, for example, a display including a touch panel and is used when the user performs various pieces of data input including input of a personal identification number, various instructions, and the like. The cash deposit/withdrawal unit 12 receives deposited coins and deposited banknotes and discharges withdrawn coins and withdrawn banknotes. The passbook reception unit 13 receives and returns a passbook. The card reception port 14 receives and returns a card used for transaction such as a cash card. The receipt issuance port 15 discharges a receipt on which the issued transaction detail is printed.

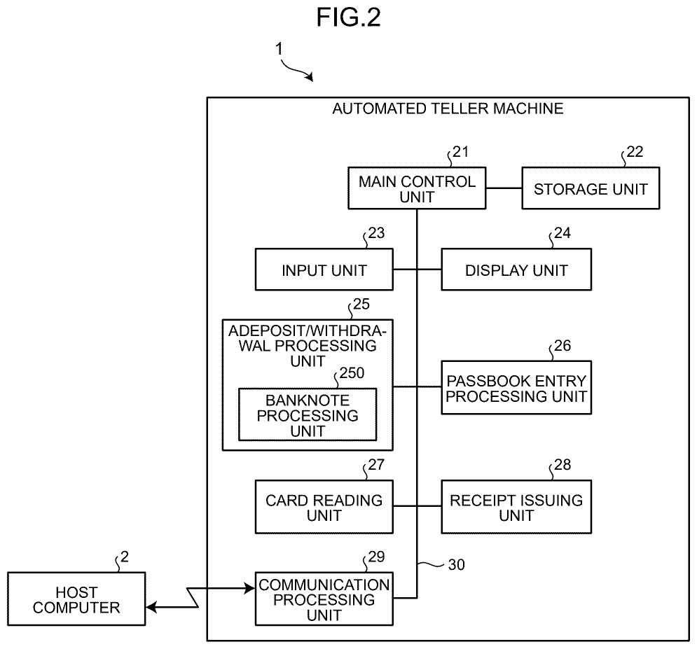

FIG. 2 is a diagram illustrating an example of a hardware configuration of the automated teller machine. As illustrated in FIG. 2, the automated teller machine 1 includes a main control unit 21, a storage unit 22, an input unit 23, a display unit 24, a deposit/withdrawal processing unit 25, a passbook entry processing unit 26, a card reading unit 27, a receipt issuing unit 28, and a communication processing unit 29. The main control unit 21, the storage unit 22, the input unit 23, the display unit 24, the deposit/withdrawal processing unit 25, the passbook entry processing unit 26, the card reading unit 27, the receipt issuing unit 28, and the communication processing unit 29 are connected to each other via a bus 30.

The main control unit 21 integrally controls the automated teller machine 1. The main control unit 21 reads a program for performing various processes of the automated teller machine 1 stored in the storage unit 22 or the like, temporarily stores the read program in an internal memory (not illustrated), and performs various processes according to the program. The main control unit 21 includes, for example, a central processing unit (CPU).

The input unit 23 and the display unit 24 include the customer operation screen 11. The user performs an operation such as selection input of a desired transaction using the input unit 23 with reference to various screens displayed on the display unit 24.

The communication processing unit 29 is used for communication with a host computer 2 via a network, for example, at the time of provision of a service of a transaction selected by the user. The communication processing unit 29 is, for example, a communication interface.

The main control unit 21 performs control for realizing a transaction instructed by an operation on the customer operation screen 11 by the user. Specifically, when the user selects and inputs a transaction from a transaction menu displayed on the display unit 24 with the input unit 23, inserts a card or a passbook, and performs a predetermined transaction operation, the main control unit 21 performs control to realize a transaction with the host computer 2 that manages various items of information such as account information, a personal identification number, and a deposit amount of the user via the communication processing unit 29.

The storage unit 22 stores an application program for performing various processes of the automated teller machine 1, data required for the process of the automated teller machine 1, and the like. The storage unit 22 is, for example, a hard disk drive.

The deposit/withdrawal processing unit 25 includes a banknote processing unit 250. The banknote processing unit 250 is a banknote conveying mechanism that performs a banknote conveying process. The banknote processing unit 250 receives the banknotes input to the cash deposit/withdrawal unit 12, and distinguishes, counts, and stores the banknotes. In addition, the banknote processing unit 250 discharges a predetermined number of banknotes from the cash deposit/withdrawal unit 12 according to the withdrawal transaction selected by the user. Note that the deposit/withdrawal processing unit 25 may include a coin processing unit that performs a process of receiving the coins put into the cash deposit/withdrawal unit 12 and distinguishing, counting, and storing the coins, and a process of discharging a predetermined number of coins from the cash deposit/withdrawal unit 12 according to the withdrawal transaction selected by the user.

The passbook entry processing unit 26 receives the passbook inserted by the user from the passbook reception unit 13, conveys the passbook to a predetermined position, writes the contents of the transaction processing, and returns the passbook for which the writing is completed from the passbook reception unit 13.

The card reading unit 27 receives a card inserted by a user from the card reception port 14, reads data such as account information from a magnetic stripe unit or an integrated circuit (IC) chip unit of the card, and returns the card from the card reception port 14. The receipt issuing unit 28 issues a receipt.

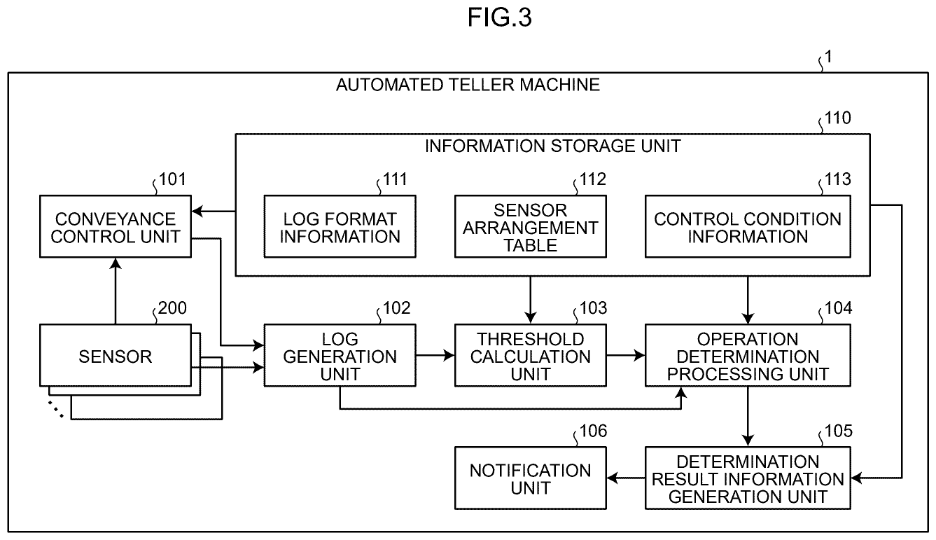

FIG. 3 is a block diagram of the automated teller machine. In FIG. 3, functions related to abnormality detection in the banknote conveyance of the automated teller machine 1 are described, and other functions are not illustrated.

As illustrated in FIG. 3, the automated teller machine 1 includes a conveyance control unit 101, a log generation unit 102, a threshold calculation unit 103, an operation determination processing unit 104, a determination result information generation unit 105, a notification unit 106, and sensors 200. The conveyance control unit 101, the log generation unit 102, the threshold calculation unit 103, the operation determination processing unit 104, and the determination result information generation unit 105 are realized by the main control unit 21 illustrated in FIG. 2.

The plurality of sensors 200 are arranged on a banknote path in the automated teller machine 1. The sensor 200 detects the presence of the conveyed banknote at a predetermined position. For example, the sensor 200 can detect passage of a banknote at a predetermined position or accumulation of a banknote at a predetermined position. The sensor 200 outputs a detection result of the conveyed banknote to the log generation unit 102.

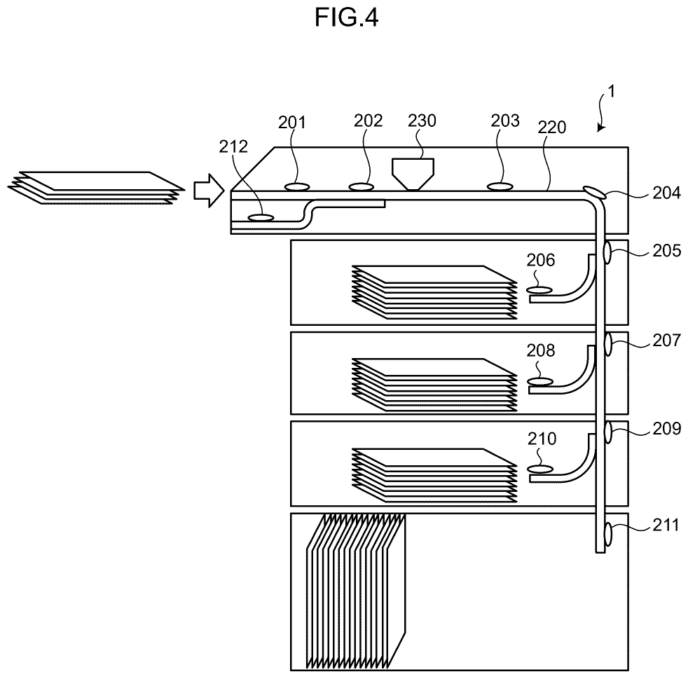

FIG. 4 is a diagram illustrating an example of arrangement of sensors. FIG. 4 illustrates sensors 201 to 212 as an example of the sensors 200. For example, the banknote processing unit 250 illustrated in FIG. 2 includes a conveyance path 220 for conveying a banknote. The conveyance path 220 is a path connecting the cash deposit/withdrawal unit 12 and the storing chamber. In addition, the banknote processing unit 250 includes a distinguishing unit 230 that determines the authenticity or the like of the banknote by distinguishing. Further, the banknote processing unit 250 includes the sensors 201 to 212 at each point on the conveyance path 220.

The sensor 201 is arranged in the vicinity of the cash deposit/withdrawal unit 12 on a path for sending banknotes from the cash deposit/withdrawal unit 12 to the inside of the apparatus. The sensor 212 is disposed in the vicinity of the cash deposit/withdrawal unit 12 on a path for sending banknotes inside the apparatus to the cash deposit/withdrawal unit 12. The sensor 202 is disposed between the sensor 201 and the distinguishing unit 230. The sensors 203 and 204 are disposed between the distinguishing unit 230 and the storing chamber. Further, the sensor 205 is disposed at a branch position of the path in the storing chamber closest to the cash deposit/withdrawal unit 12 in the conveyance path 220. The sensor 206 is disposed at a place where the banknote of the storing chamber closest to the cash deposit/withdrawal unit 12 is stored on the conveyance path 220. Further, the sensor 207 is disposed at a branch position of the path in the storing chamber second closest to the cash deposit/withdrawal unit 12 in the conveyance path 220. The sensor 208 is disposed at a place where the banknote of the storing chamber second closest to the cash deposit/withdrawal unit 12 is stored on the conveyance path 220. Further, the sensor 209 is disposed at a branch position of the path in the storing chamber third closest to the cash deposit/withdrawal unit 12 in the conveyance path 220. The sensor 210 is disposed at a place where the banknote of the storing chamber third closest to the cash deposit/withdrawal unit 12 is stored on the conveyance path 220. In addition, the sensor 211 is disposed at a place where the banknote of the storing chamber farthest from the cash deposit/withdrawal unit 12 is stored on the conveyance path 220.

Each of the sensors 201 to 205, 207, 209, and 212 detects passage of a banknote. In addition, each of the sensors 206, 208, 210, and 211 detects a banknote stored in the storing chamber.

Referring back to FIG. 3, the description is continued. An information storage unit 110 is realized by the storage unit 22 illustrated in FIG. 2. The information storage unit 110 stores a log format information 111, a sensor arrangement table 112, and a control condition information 113.

Information in a description format of a log in which a history of the operation of the automated teller machine 1 is described is registered in the log format information 111. For example, in the log format information 111, information indicating which item in the log is the time stamp, which item is the operation subject, and which item is the operation content is registered.

Information indicating how the sensors 200 are arranged in the banknote processing unit 250 illustrated in FIG. 2 is registered in the sensor arrangement table 112. In the present embodiment, arrangement information of the sensors 201 to 212 illustrated in FIG. 4 is registered in the sensor arrangement table 112.

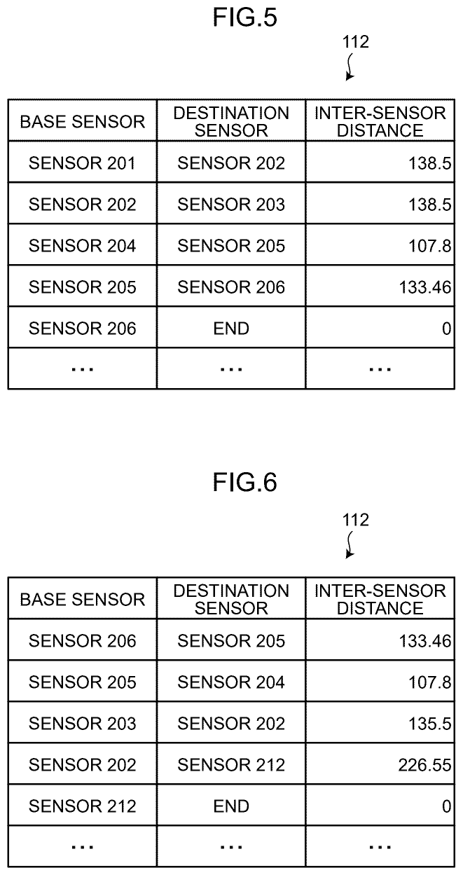

There are two types of the sensor arrangement table 112 according to the present embodiment: a feed direction that is a direction in which banknotes flow in a case where the banknotes are taken into the automated teller machine 1; and a back direction that is a direction in which the banknotes flow in a case where the banknotes in the automated teller machine 1 are discharged. FIG. 5 is a diagram of an example of a sensor arrangement table in a feed direction. FIG. 6 is a diagram of an example of a sensor arrangement table in a back direction.

For example, in both the sensor arrangement table 112 in the feed direction and the back direction, a base sensor through which the banknote passes first and a destination sensor to which the banknote that passes through the base sensor reaches next are registered along the flow of the banknote. In FIGS. 5 and 6, “END” indicates that banknotes are accumulated at the place. In the sensor arrangement table 112, the sensors 201 to 212 are registered in the order from the start candidate sensor that can be the start position to the end candidate sensor that can be the last position in the conveyance path determined as a series of conveyance in the conveyance of the banknote.

For example, as illustrated in the sensor arrangement table 112 of FIG. 5, in the feed direction, the sensors 201 to 203 are sequentially arranged on a series of conveyance paths, the sensor 201 is a start candidate sensor, and the sensor 203 is an end candidate sensor. For example, as illustrated in the sensor arrangement table 112 of FIG. 6, in the back direction, the sensors 204 to 206 are sequentially arranged on a series of conveyance paths, the sensor 206 is a start candidate sensor, and the sensor 204 is an end candidate sensor.

Furthermore, in the sensor arrangement table 112, an inter-sensor distance between the base sensor and the destination sensor is registered. For example, as illustrated in the sensor arrangement table 112 of FIG. 5, the inter-sensor distance between the sensor 201 as the base sensor and the sensor 202 as the destination sensor is 138.5 mm.

The control condition information 113 indicates a control condition for irregular handling in the banknote conveying process. For example, an abnormality determination threshold for detecting an abnormality in banknote conveyance determined in advance in the firmware is registered. In the present embodiment, the abnormality determination threshold is represented by a banknote conveying speed. For example, as the abnormality determination threshold, the upper limit threshold of the conveying speed is set to 1500 mm/s, and the lower limit threshold is set to 375 mm/s.

For example, the conveyance control unit 101 performs control such as start and stop of driving of the motor in the banknote conveying process. In addition, the conveyance control unit 101 acquires detection information of the conveyed banknote of each sensor 200, calculates the conveying speed, compares the detection information with the abnormality determination threshold registered in the control condition information 113, and detects the abnormality in the conveying process. For example, the conveyance control unit 101 determines whether an abnormality occurs depending on whether the conveying speed is included in the range indicated by the abnormality determination threshold, with the range sandwiched between the abnormality determination thresholds of the upper limit value and the lower limit value as the range indicated by the abnormality determination threshold. When the abnormality is detected, the conveyance control unit 101 stops the banknote conveying process. In addition, the conveyance control unit 101 outputs information of the executed control to the log generation unit 102.

The log generation unit 102 receives an input of information of the control executed in the banknote conveying process from the conveyance control unit 101. Here, the log generation unit 102 also receives input of information of control for the process executed in the automated teller machine 1 other than the banknote conveying process. In addition, the log generation unit 102 receives an input of the detection result of the banknote in the banknote conveying process from each sensor 200.

Then, the log generation unit 102 generates a log that is a history of various processes executed in the automated teller machine 1 of FIG. 2 including the banknote conveying process. The log generation unit 102 creates a log according to the format stored in the log format information 111. The log generation unit 102 outputs the generated log in response to the log acquisition request from the threshold calculation unit 103 and the operation determination processing unit 104.

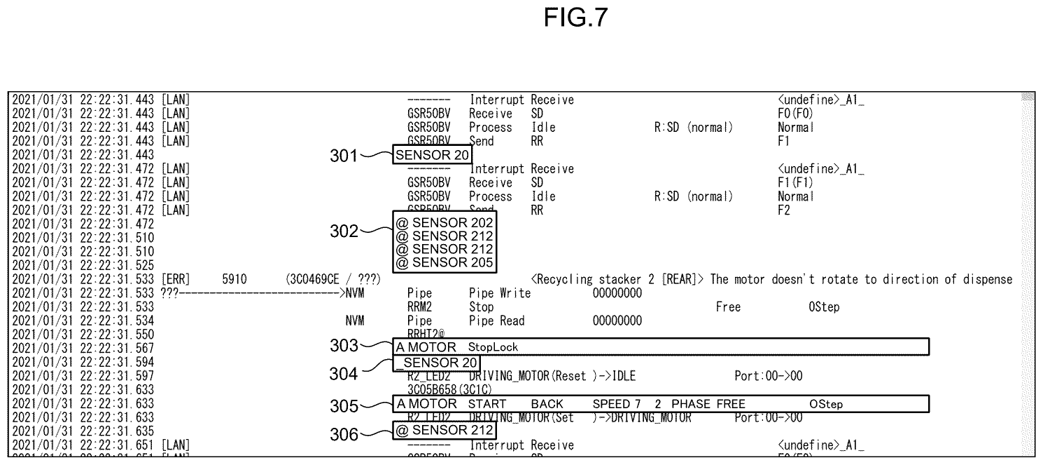

FIG. 7 is a diagram illustrating an example of a log in the automated teller machine. As illustrated in FIG. 7, the log generation unit 102 generates a log in which information of control and information such as a detection result by the sensor 200 are registered in time series together with a time stamp. For example, in FIG. 7, portions surrounded by frame lines 301, 302, 304, and 306 indicate detection results of the sensors 200. Portions surrounded by frame lines 303 and 305 indicate information on control such as start and stop of driving of the motor.

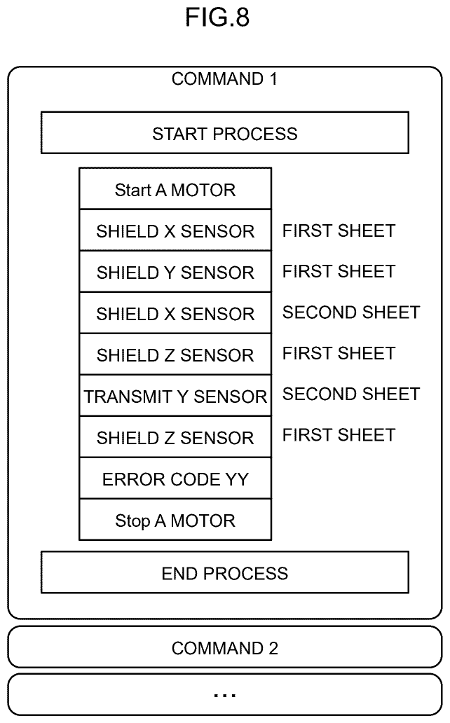

FIG. 8 is a diagram illustrating an outline of a banknote conveying process indicated by a log. In FIG. 8, the outline of the banknote conveying process indicated by the log is described with an example of a case where the X sensor, the Y sensor, and the Z sensor are present as the sensors 200 and the A motor is driven. The contents of the log can be distinguished for each command related to the banknote conveying process. Then, information on control performed from the start to the end of the process for each command and a detection result of the sensor 200 can be read from the log in chronological order.

The threshold calculation unit 103 transmits a log acquisition request to the log generation unit 102 and acquires a log as a response thereto. Further, the threshold calculation unit 103 refers to the log format information 111 and the sensor arrangement table 112. Then, using the arrangement of the sensors 200 obtained from the sensor arrangement table 112, the threshold calculation unit 103 calculates an abnormality tendency threshold for detecting an abnormality tendency from the information registered in the log according to the format of the log obtained from the log format information 111. The threshold calculation unit 103 can calculate the abnormality tendency threshold after a predetermined number of days elapse from the start of operation of the automated teller machine 1 or after a predetermined number of banknotes are conveyed.

For example, the threshold calculation unit 103 calculates the conveying speed in the inter-sensor conveyance of the banknote from each base sensor registered in the sensor arrangement table 112 to the destination sensor. For example, the threshold calculation unit 103 extracts, from the log, information on the inter-sensor conveyance of the banknote from each base sensor registered in the sensor arrangement table 112 to the destination sensor. Then, the threshold calculation unit 103 acquires the elapsed time in each piece of inter-sensor conveyance extracted using the time stamp. Thereafter, the threshold calculation unit 103 divides the elapsed time by the inter-sensor distance registered in the sensor arrangement table 112 to calculate the banknote conveying speed in each piece of inter-sensor conveyance. The threshold calculation unit 103 accumulates conveying speed information in each piece of inter-sensor conveyance.

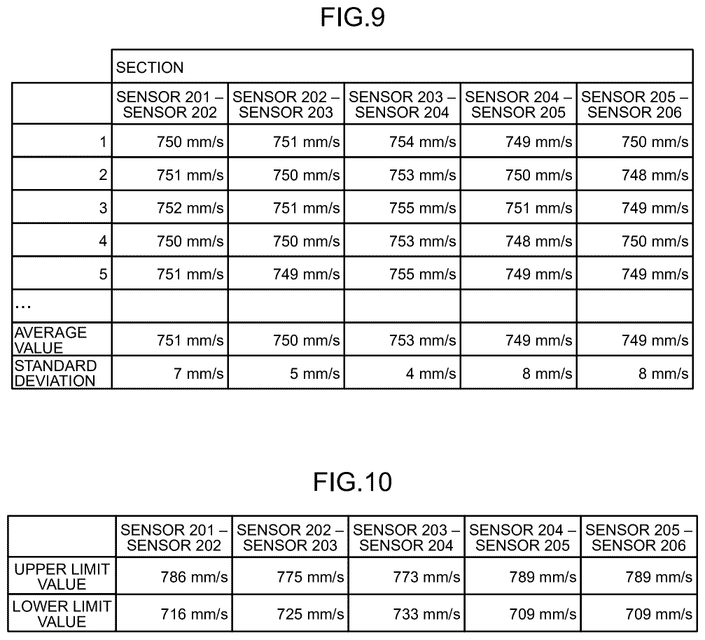

FIG. 9 is a diagram illustrating an accumulation example of conveying speed information. For example, the threshold calculation unit 103 accumulates conveying speed information of inter-sensor conveyance between the sensor 201 and the sensor 202, between the sensor 202 and the sensor 203, between the sensor 203 and the sensor 204, between the sensor 204 and the sensor 205, and between the sensor 205 and the sensor 206.

Next, the threshold calculation unit 103 calculates each reference value using the conveying speed information in each inter-sensor conveyance. Then, the threshold calculation unit 103 calculates an abnormality tendency threshold having a difference from the calculated reference value to the extent in which the difference can be determined as an abnormality sign.

For example, as illustrated in FIG. 9, the threshold calculation unit 103 calculates an average value of the conveying speed information for each item of inter-sensor conveyance. Further, as illustrated in FIG. 9, the threshold calculation unit 103 calculates the standard deviation of the conveying speed information for each item of inter-sensor conveyance. Then, the threshold calculation unit 103 adds a value obtained by multiplying the standard deviation by a predetermined deviation coefficient to the value of the average value of the conveying speed information to calculate the upper limit value of the abnormality tendency threshold. In addition, the threshold calculation unit 103 calculates the lower limit value of the abnormality tendency threshold by subtracting a value obtained by multiplying the standard deviation by the predetermined deviation coefficient from the average value of the conveying speed information.

For example, when the deviation coefficient is 5, the threshold calculation unit 103 sets the upper limit value of the abnormality tendency threshold to be the average value+(the standard deviation×5) and sets the lower limit value of the abnormality tendency threshold to be the average value−(the standard deviation×5). In addition, when the deviation coefficient is 10, the threshold calculation unit 103 sets the upper limit value of the abnormality tendency threshold to be the average value+(the standard deviation×10) and sets the lower limit value of the abnormality tendency threshold to be the average value−(the standard deviation×10).

FIG. 10 is a diagram illustrating an example of an abnormality tendency threshold. For example, the threshold calculation unit 103 calculates the upper limit values and the lower limit values of the abnormality tendency thresholds of the inter-sensor conveyance between the sensor 201 and the sensor 202, between the sensor 202 and the sensor 203, between the sensor 203 and the sensor 204, between the sensor 204 and the sensor 205, and between the sensor 205 and the sensor 206, illustrated in FIG. 10, from the average value and the standard deviation in the conveying speed information illustrated in FIG. 9.

Then, the threshold calculation unit 103 outputs the calculated abnormality tendency thresholds to the operation determination processing unit 104. In the present embodiment, the threshold calculation unit 103 outputs the upper limit value and the lower limit value of the abnormality tendency threshold to the operation determination processing unit 104.

Referring back to FIG. 3, the description is continued. The operation determination processing unit 104 acquires the abnormality tendency threshold from the threshold calculation unit 103. Thereafter, the operation determination processing unit 104 periodically transmits a log acquisition request to the log generation unit 102 and acquires a log as a response thereto. Further, the operation determination processing unit 104 refers to the log format information 111 and the sensor arrangement table 112. Then, using the arrangement of the sensors 200 obtained from the sensor arrangement table 112, the threshold calculation unit 103 calculates the conveying speed at each item of inter-sensor conveyance from the information registered in the log according to the format of the log obtained from the log format information 111.

For example, the operation determination processing unit 104 performs a rendering process described below and calculates the conveying speed in the inter-sensor conveyance of the banknote from each base sensor registered in the sensor arrangement table 112 to the destination sensor. By performing the rendering process, the operation determination processing unit 104 can also acquire, for each command, information indicating the flow of conveyance of the respective banknotes in the order of the sensors 200 that detect the banknotes, that is, information indicating whether the banknotes flow in the feed direction or the back direction.

For example, the operation determination processing unit 104 extracts a log having a pair of start and end of driving of the motor from the entire log as a log for each command instructing the banknote conveyance. Next, the operation determination processing unit 104 specifies the conveying direction of the banknote from the extracted log. Next, the operation determination processing unit 104 refers to the sensor arrangement table corresponding to the specified banknote conveying direction. Then, the operation determination processing unit 104 selects a set of the base sensor and the destination sensor in order from the sensor 200 corresponding to the start candidate sensor of the extracted log according to the banknote conveyance and acquires each sensor detection log. Next, the operation determination processing unit 104 acquires the elapsed time in the inter-sensor conveyance between the base sensor and the destination sensor using the time stamp of the extracted sensor detection log. Thereafter, the operation determination processing unit 104 divides the elapsed time by the inter-sensor distance registered in the sensor arrangement table 112 to calculate the banknote conveying speed in each piece of inter-sensor conveyance between the base sensor and the destination sensor. The operation determination processing unit 104 calculates the banknote conveying speed in the inter-sensor conveyance between the base sensor and the destination sensor for each sensor 200 from the start candidate sensor to the end candidate sensor included in the extracted log for each command. Further, the operation determination processing unit 104 calculates the banknote conveying speed in the inter-sensor conveyance between the base sensor and the destination sensor in the same manner for all the commands for the entire log.

Thereafter, the operation determination processing unit 104 compares the conveying speed in each inter-sensor conveyance calculated by the rendering process with the abnormality tendency threshold and detects the occurrence of an abnormality sign in the inter-sensor conveyance. In the present embodiment, the operation determination processing unit 104 determines the presence or absence of an abnormality sign depending on whether the conveying speed is included in the range indicated by the abnormality tendency threshold, using the range sandwiched between the abnormality tendency thresholds of the upper limit value and the lower limit value as the range indicated by the abnormality tendency threshold.

For example, the operation determination processing unit 104 detects the occurrence of an abnormality sign in a case where the conveying speed exceeds the upper limit value of the abnormality tendency threshold or in a case where the conveying speed falls below the lower limit value of the abnormality tendency threshold. Then, the operation determination processing unit 104 extracts the inter-sensor conveyance in which the occurrence of the abnormality sign is detected. Thereafter, the operation determination processing unit 104 outputs the detection result of the occurrence of the abnormality sign including the information on the extracted inter-sensor conveyance to the determination result information generation unit 105.

Further, the operation determination processing unit 104 may acquire information of the abnormality determination threshold from the control condition information 113, compare the calculated conveying speed in the inter-sensor conveyance with the abnormality determination threshold, and detect the occurrence of an abnormality. In this case, the operation determination processing unit 104 may output the detection result of the abnormality occurrence to the determination result information generation unit 105.

One of the large number of banknotes for which the operation determination processing unit 104 determines the presence or absence of the abnormality sign corresponds to the specific banknote, and the specific banknote conveying speed calculated by the operation determination processing unit 104 corresponds to an example of the first conveying speed. That is, the operation determination processing unit 104 calculates the first conveying speed of the specific banknote between the sensors 200 based on the log and determines the presence or absence of the abnormality sign in the conveyance of the specific banknote between the sensors 200 based on whether the first conveying speed is included in the range indicated by the abnormality tendency threshold.

The determination result information generation unit 105 receives an input of a detection result of occurrence of an abnormality sign from the operation determination processing unit 104. Then, the determination result information generation unit 105 generates determination result information for providing notification of the detection result of the occurrence of the abnormality sign. For example, the determination result information generation unit 105 may add the occurrence time of the abnormality sign to the information of the base sensor that performs the inter-sensor conveyance in which the occurrence of the abnormality sign is detected and the sensor 200 that is the destination sensor to make a list, thereby obtaining the determination result information. Thereafter, the determination result information generation unit 105 notifies the notification unit 106 of the generated determination result information.

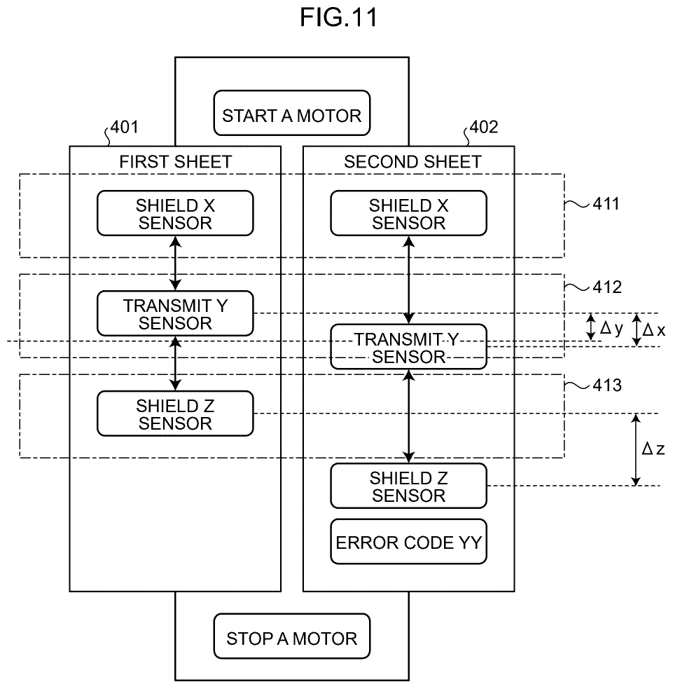

FIG. 11 is a diagram illustrating an example of determination result information. In addition, the determination result information generation unit 105 may generate determination result information illustrating the occurrence of an abnormality sign as illustrated in FIG. 11. FIG. 11 is an example illustrating a determination result based on the outline of the banknote conveying process illustrated in FIG. 8.

For example, the determination result information generation unit 105 receives an input of the detection result of the abnormality occurrence together with the detection result of the occurrence of the abnormality sign from the operation determination processing unit 104. As the detection result of the occurrence of the abnormality sign, the determination result information generation unit 105 also acquires information on the command in which the occurrence of the abnormal sign is detected, information on the flow of the banknote in the processing of the command, and the used abnormality tendency threshold from the operation determination processing unit 104. In addition, the determination result information generation unit 105 refers to the sensor arrangement table 112 to acquire the arrangement of the sensors 200. In addition, the determination result information generation unit 105 acquires the abnormality determination threshold from the control condition information 113.

Then, as illustrated in FIG. 11, the determination result information generation unit 105 creates, for each banknote, path diagrams 401 and 402 in which the sensors 200 are arranged according to information on the flow of the banknote from the start to the stop of driving of the motor for each command. Next, the determination result information generation unit 105 displays ranges 411 to 413 by converting the abnormality tendency threshold into a distance for each item of inter-sensor conveyance. Further, the determination result information generation unit 105 illustrates a line 422 indicating Δy obtained by converting the abnormality tendency threshold into a distance in the inter-sensor conveyance in which the occurrence of the abnormality sign is detected. In addition, the determination result information generation unit 105 moves the Y sensor to the movement distance in the case of the speed corresponding to the reference value from the time taken when the second banknote illustrated in a path diagram 402 is conveyed from the X sensor to the Y sensor. Then, Δx that is a deviation from the position of the sensor 200 when the speed is the reference value is illustrated. As a result, since Δx is longer than Δy, the determination result information generation unit 105 can indicate that an abnormality sign occurs in the inter-sensor conveyance from the X sensor to the Y sensor. In addition, the determination result information generation unit 105 similarly moves the Z sensor to a position calculated from the conveying speed. In this case, since Δz that is a deviation from the position of the sensor 200 when the speed is the reference value exceeds the range 413 indicating the abnormality tendency threshold, the determination result information generation unit 105 can indicate that an abnormality occurs in the inter-sensor conveyance from the Y sensor to the Z sensor.

Referring back to FIG. 3, the description is continued. The notification unit 106 receives an input of determination result information including information on inter-sensor conveyance in which occurrence of an abnormality sign is detected from the determination result information generation unit 105. Then, the notification unit 106 transmits determination result information to the host computer 2 via the communication processing unit 29 illustrated in FIG. 2 and notifies the administrator of the determination result including information on inter-sensor conveyance in which occurrence of an abnormality sign is detected. The notification unit 106 is realized by the main control unit 21 and the communication processing unit 29 illustrated in FIG. 2.

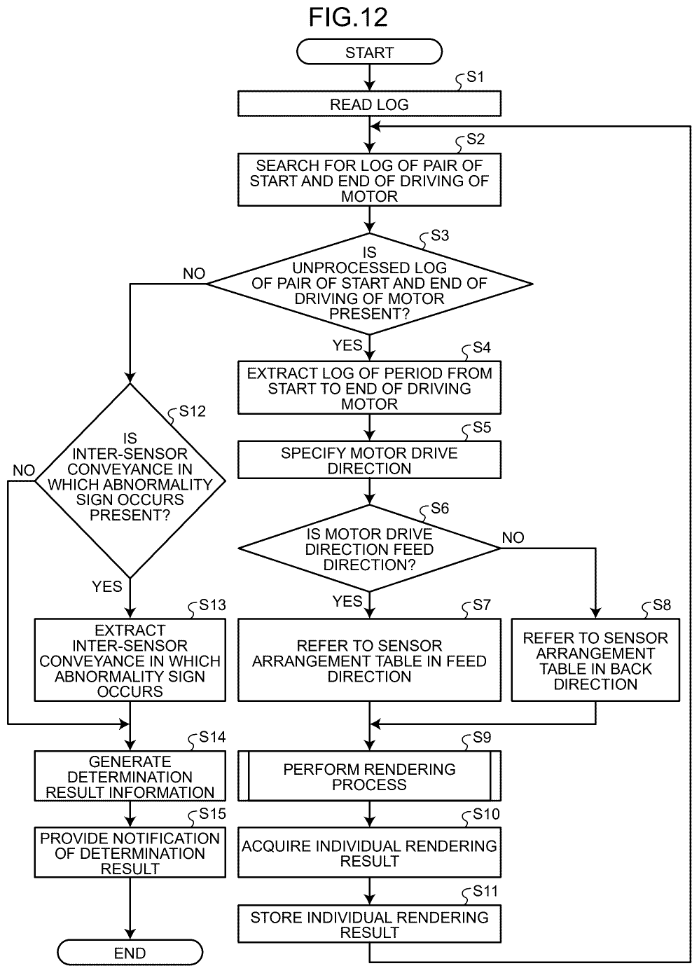

FIG. 12 is a flowchart of an abnormality sign detection process in banknote conveyance by the automated teller machine according to the embodiment. Next, a flow of the abnormality sign detection process in the banknote conveyance by the automated teller machine 1 according to the embodiment is described with reference to FIG. 12.

The operation determination processing unit 104 reads the log generated by the log generation unit 102 (Step S1).

Next, the operation determination processing unit 104 searches for a log of a pair of start and end of driving of the motor (Step S2).

Then, the operation determination processing unit 104 determines whether an unprocessed log of the pair of start and end of driving of the motor is present (Step S3).

If an unprocessed log of the pair of start and end of driving of the motor is present (Step S3: Yes), the operation determination processing unit 104 extracts one log of a period from the start to the end of driving of the motor (Step S4).

Next, the operation determination processing unit 104 refers to the extracted log to specify the motor drive direction (Step S5).

Then, the operation determination processing unit 104 determines whether the motor drive direction is the feed direction (Step S6).

When the motor drive direction is the feed direction (Step S6: Yes), the operation determination processing unit 104 refers to the sensor arrangement table 112 in the feed direction (Step S7).

In contrary, when the motor drive direction is the back direction (Step S6: No), the operation determination processing unit 104 refers to the sensor arrangement table 112 in the back direction (Step S8).

Next, the operation determination processing unit 104 performs the rendering process using the log format information 111 and the sensor arrangement table 112 based on the extracted log (Step S9).

Next, the operation determination processing unit 104 acquires an individual rendering result for the extracted log (Step S10).

Then, the operation determination processing unit 104 stores an individual rendering result for the extracted log in a temporary storage area held by itself (Step S11). Thereafter, the operation determination processing unit 104 returns to Step S2.

Meanwhile, when the entire processes of the log of the pair of start and end of driving of the motor included in the acquired log are completed (Step S3: No), the operation determination processing unit 104 compares the conveying speed in each item of inter-sensor conveyance calculated by the rendering process with the abnormality tendency threshold and detects the occurrence of an abnormality sign. Then, the operation determination processing unit 104 determines whether inter-sensor conveyance in which an abnormality sign occurs is present (Step S12). When inter-sensor conveyance in which an abnormality sign occurs is not present (Step S12: No), the operation determination processing unit 104 proceeds to Step S14.

Meanwhile, when inter-sensor conveyance in which an abnormality sign occurs is present (Step S12: Yes), the operation determination processing unit 104 extracts inter-sensor conveyance in which an abnormality sign occurs (Step S13).

Thereafter, the determination result information generation unit 105 generates determination result information including information on inter-sensor conveyance in which occurrence of an abnormality sign notification of which is provided by the operation determination processing unit 104 is detected (Step S14).

The notification unit 106 transmits the determination result information generated by the determination result information generation unit 105 to the host computer 2 to notify the administrator of the information on the inter-sensor conveyance in which the occurrence of the abnormality sign is detected (Step S15).

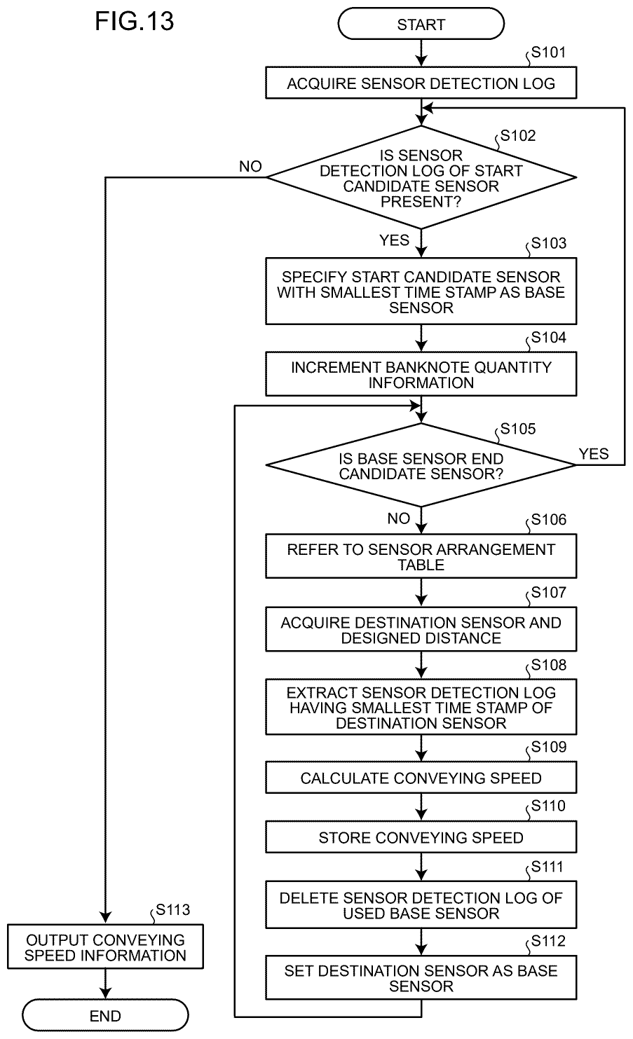

FIG. 13 is a flowchart of a rendering process by the automated teller machine according to the embodiment. Each process illustrated in FIG. 13 corresponds to an example of the process executed in Step S9 in FIG. 12. Next, a flow of the rendering process by the automated teller machine 1 according to the embodiment is described with reference to FIG. 13.

The operation determination processing unit 104 acquires a sensor detection log in which detection information by the sensor 200 is described from among the extracted logs (Step S101).

Next, the operation determination processing unit 104 determines whether a sensor detection log notification of which is provided by the sensor 200 that is a start candidate sensor is present among the acquired sensor detection logs (Step S102).

When a sensor detection log notification of which is provided by the sensor 200 that is a start candidate sensor is present (Step S102: Yes), the operation determination processing unit 104 specifies a start candidate sensor with the smallest time stamp as a base sensor (Step S103).

Next, the operation determination processing unit 104 increments the banknote quantity information (Step S104). As a result, when a plurality of banknotes are processed in a series of processes executed by one command, the operation determination processing unit 104 can distinguish the conveying process of each banknote.

Next, the operation determination processing unit 104 determines whether the base sensor is an end candidate sensor (Step S105). When the base sensor is an end candidate sensor (Step S105: Yes), the operation determination processing unit 104 returns to Step S102.

Meanwhile, when the base sensor is not an end candidate sensor (Step S105: No), the operation determination processing unit 104 refers to the sensor arrangement table 112 (Step S106).

Then, the operation determination processing unit 104 acquires a destination sensor for the base sensor and a designed distance that is the inter-sensor distance between the base sensor and the destination sensor (Step S107).

Next, the operation determination processing unit 104 extracts a sensor detection log having the smallest time stamp of the destination sensor (Step S108).

Next, the operation determination processing unit 104 calculates the time taken for the inter-sensor conveyance between the base sensor and the destination sensor using the time stamp and calculates the conveying speed by dividing the calculated time by the designed distance (Step S109).

Next, the operation determination processing unit 104 stores the calculated conveying speed in a temporary storage area thereof (Step S110).

Next, the operation determination processing unit 104 deletes the sensor detection log of the used base sensor from the acquired log (Step S111).

Next, the operation determination processing unit 104 sets the destination sensor as a base sensor (Step S112). Thereafter, the operation determination processing unit 104 returns to Step S105.

Meanwhile, when the sensor detection log notification of which is provided by the sensor 200 that is the start candidate sensor is not present (Step S102: No), the operation determination processing unit 104 outputs the conveying speed information in each item of the inter-sensor conveyance stored in the temporary storage area (Step S113).

As described above, the automated teller machine according to the present embodiment that is the banknote conveying apparatus calculates the abnormality tendency threshold from the conveyance state of the banknotes conveyed in a large amount, specifies the conveyance of the banknote of which the conveying speed exceeds the abnormality tendency threshold from the log, and detects occurrence of the abnormality sign.

As described above, by detecting occurrence of the abnormality sign at a stage before the abnormality actually occurs, the abnormality factor in the banknote in which the abnormality occurs can be extracted from the comparison with other normal banknotes according to the characteristics of the banknote conveying apparatus that causes a large amount of banknotes to flow. That is, an abnormality factor of the banknote conveying process can be detected in accordance with the characteristics of the banknote conveying apparatus without limiting to the time or place of occurrence of the abnormality, and thus appropriate identification of the abnormality factor can be realized. As a result, since the identification of the abnormality factor is a basic comparison work, even a person who is not familiar with the banknote conveying apparatus can analyze the abnormality factor in the banknote conveying process, and automation is also facilitated. Therefore, maintainability can be improved.

Further, in the present embodiment, the automated teller machine is described as an example of the banknote conveying apparatus, but the present invention is not limited thereto as long as the apparatus conveys a banknote. For example, a self-check out system (SCO system) such as a self-checkout, a ticket machine, and the like are also banknote conveying apparatuses, and the mechanism described in the above embodiment can be adopted.

According to one aspect of the banknote conveying apparatus, the banknote conveying method, and the banknote conveying program described in the present application, the effect of improving maintainability can be exhibited.

What is claimed is:

1. A banknote conveying apparatus comprising:
a conveyance controller that performs a conveying process of sequentially conveying a plurality of banknotes on a conveyance path;
a plurality of sensors that are provided on the conveyance path and detect the conveyed banknotes;
a memory; and
a processor coupled to the memory and configured to:
generate a log in which past operation information including a detection result by the sensor is recorded;
calculate an abnormality tendency threshold of a conveying speed for conveying a banknote between the sensors based on detection results of the sensors for the plurality of conveyed banknotes included in the log;
calculate a first conveying speed of a specific banknote between the sensors based on the log and determine presence or absence of an abnormality sign in conveyance of the specific banknote between the sensors based on whether the first conveying speed is included in a range indicated by the abnormality tendency threshold; and
provide notification of a determination result.

2. The banknote conveying apparatus according to claim 1,
wherein the processor is further configured to, stop the conveying process when the conveying speed is out of a range indicated by a predetermined abnormality determination threshold, and
calculate the abnormality determination threshold in which a range indicated by the abnormality determination threshold is included in a range indicated by the abnormality determination threshold.

3. The banknote conveying apparatus according to claim 1, wherein the processor is further configured to, calculate a reference value for the first conveying speed based on detection results of the plurality of conveyed banknotes by the sensors and calculate the abnormality tendency threshold based on the reference value and information on a deviation from the reference value indicating an abnormality tendency.

4. The banknote conveying apparatus according to claim 1, wherein the processor is further configured to, extract conveyance information of the specific banknote from the log based on a sensor arrangement table indicating the arrangement of the sensors and calculate the first conveying speed from the extracted conveyance information of the specific banknote.

5. A banknote conveying method causing a banknote conveying apparatus including a plurality of sensors that are provided on a conveyance path conveying banknotes and detect the conveyed banknotes, the banknote conveying method comprising:
performing a conveying process of sequentially conveying a plurality of banknotes on the conveyance path;
generating a log in which past operation information including a detection result by the sensor is recorded;
calculating an abnormality tendency threshold of a conveying speed for conveying a banknote between the sensors based on detection results of the sensors for the plurality of conveyed banknotes included in the log;
calculating a first conveying speed of a specific banknote between the sensors based on the log and determining presence or absence of an abnormality sign in conveyance of the specific banknote between the sensors based on whether the first conveying speed is included in a range indicated by the abnormality tendency threshold; and
providing notification of a determination result.

6. A non-transitory computer-readable recording medium having stored therein a banknote conveying program that causes a computer to perform a process comprising:
performing a conveying process of sequentially conveying a plurality of banknotes on a conveyance path;
generating a log in which past operation information including a detection result by the plurality of sensors that are provided on the conveyance path and detect the conveyed banknotes is recorded;
calculating an abnormality tendency threshold of a conveying speed for conveying a banknote between the sensors based on detection results of the sensors for the plurality of conveyed banknotes included in the log;
calculating a first conveying speed of a specific banknote between the sensors based on the log and determining presence or absence of an abnormality sign in conveyance of the specific banknote between the sensors based on whether the first conveying speed is included in a range indicated by the abnormality tendency threshold; and
providing notification of a determination result.
